(19) United States
(12) Patent Application Publication
(10) Pub. No.: US 2003/0201990 A1
(43) Pub. Date: Oct. 30, 2003

(54) Color adaptation for multimedia devices

(76) Inventors: Bradley C. Aldrich, Austin, TX (US); Moinul H. Khan, Austin, TX (US); Nigel C. Paver, Austin, TX (US); Lawrence A. Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/123,647

(22) Filed: Apr. 16, 2002

(51) Int. Cl. G09G 5/00

(52) U.S. Cl. 345/211

(57) ABSTRACT

An adaptive color depth control may receive input signals from a power mode block, an ambient light sensor and/or a resource usage monitor to adjust the performance of a system through adaptation of the number of bits-per-pixel for each of the three primary colors supplied to a display. The spatial resolution may be adapted in a similar manner with inputs from the power mode block, ambient light sensor, and/or resource usage monitor.

Microprocessors with embedded memory arrays are used in a diversity of consumer products. The trend toward portable products suggests conserving power by device process scaling to reduce the silicon area in an effort to lower the product costs and lowering the operating voltage of the system. However, microprocessor systems used in multimedia applications pose additional problems, especially with the inclusion of display panels to support video and image data. These systems store and transfer significant amounts of image data to support the refresh rate of the display panel. The bandwidth of the system may be dominated by the data traffic from the microprocessor to the memory combined with the data traffic from the memory to the display panel. Of particular importance in these handheld portable systems is the increase in power consumption that results from the data traffic.

The high bandwidth of the system may provide the consumer with an esthetically pleasing multimedia device, but may also cause an appreciable power drain. Thus, there is a continuing need for better ways to provide flexibility multimedia applications while preserving low operating power consumption.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block representation of a microprocessor core and memory blocks in accordance with an embodiment of the present invention; and

FIG. 2 is a block diagram that further illustrates control inputs within the display control block of FIG. 1.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the present invention may be used in a variety of applications. Although the present invention is not limited in this respect, the circuits disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also include circuit blocks referred to as core memory, cache memory, or other types of memory that store electronic instructions to be executed by the microprocessor, store data that may be used in arithmetic operations or store image data that may be visually displayed. Note that the embodiments may be integrated into radio systems or hand-held portable devices. Thus, laptop computers, cellular radiotelephone communication systems, two-way radio communication systems, one-way pagers, two-way pagers, personal communication systems (PCS), personal digital assistants (PDA's), cameras, camcorders and other products are intended to be included within the scope of the present invention.

It should be appreciated that circuitry is shown and described as digital circuitry, but that the principles and teachings of the present invention are not so constrained. In many systems, digital signal processing is preferred, while other systems may include analog circuits and signals and derive specific benefits. For example, the microprocessor may include modulation functions or a graphics generator that provides graphics and/or textual data for overlaying on a video image that may best be implemented in the analog domain. Still other functions may be performed by combining analog and digital processing to benefit from specific advantages of both kinds of signals.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

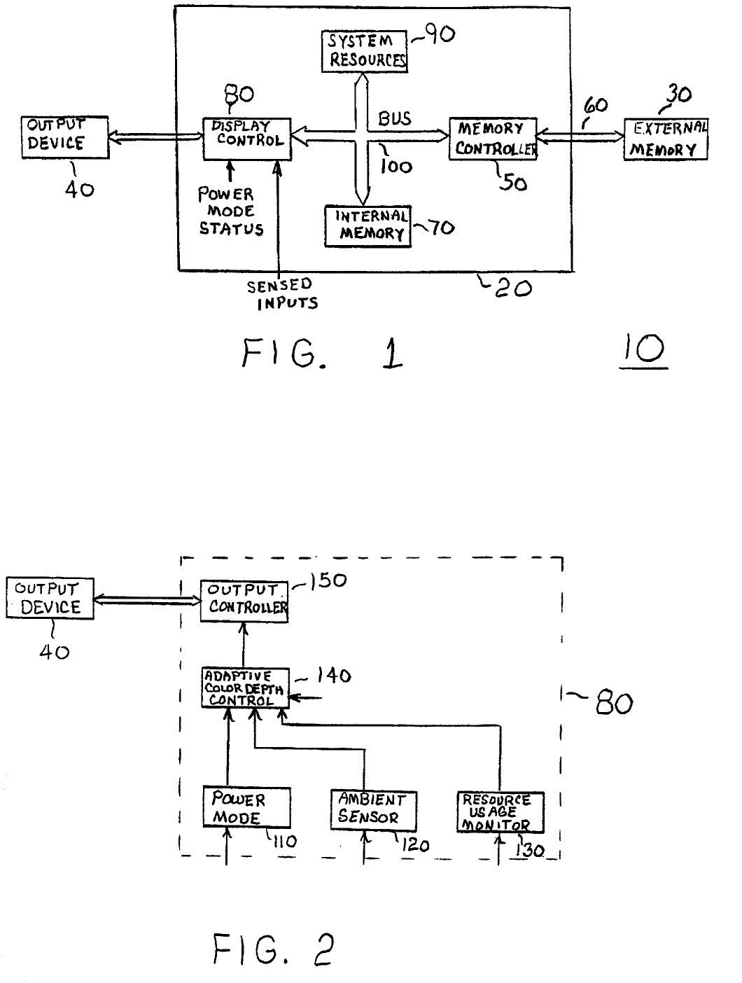

Turning to FIG. 1, system 10 may be described as a microprocessor core 20 that interfaces with an external memory block 30 and an output device 40. Address lines and control signals may be passed from microprocessor core 20 to external memory block 30. Microprocessor core 20 includes a memory control block 50 for transferring data via a bus 60 to/from memory block 30. Microprocessor core 20 further includes an internal memory block 70, a display control block 80, and a system resource block 90 that may be connected to each other and to memory control block 50 via a bus 100. External memory block 30 and internal memory block 70 may be a Static Random Access Memory (SRAM) or a Dynamic Random Access Memory (DRAM) and store software instructions for operating microprocessor core 20. Alternatively, these memory blocks may be a non-volatile memory such as, for example, a flash memory or a ferroelectric memory, although the memory type is not intended to limit the scope of the claimed subject mater.

Typically, the data stored in either external memory block 30 or internal memory block 70 may be captured by an image capturing system that converts an image to digital data for storage in a format recognizable by output device 40. Photoactive devices capture the image and provide pixel signals whose voltage may be correlated to the intensity and color of light. In a color system, the light may pass through color filters to produce pixel signals that represent a primary color component. Thus, an image such as a photograph, line drawing, text document or other image may be converted to a digitized form and saved in either external memory block 30 or internal memory block 70 in a particular image file format.

The file format, for example, may be an RGB24 image, also known as true color, or a BGR24 image that is the same as a RGB24 image but with the colors (red, green, and blue) in a different order. The number of bits-per-pixel supplied to the display for each of the three primary colors may be represented by a format having any number of bits, though some formats may be more common than others. For instance, an RGB24 format has 24 bits-per-pixel (bpp) and represents 8 bits of data for each of the red, green and blue values. Other formats with fewer than 24 bpp may be supported by display control block 80. The image data presented to output device 40 may also have a format where the red, green and blue values may not be the same such as, for example, an RGB 5:6:5 format. It is not intended that the present invention be limited by the number of bits-per-pixel supplied to the display or whether the colors for the pixel have the same or differing numbers of bits.

A BGR24 image type has 24 bits of data per pixel, i.e., eight bits-per-pixel for each of the three primary colors blue, green, and red. This translates to 256 shades of each primary color to provide about 16 million colors for each image. It should be pointed out that microprocessor core 20 may convert between image file formats by processing the red, green and blue data. By way of example, an RGB format may be converted to a YUV format using the following formulas:

Y=(0.257*R)+(0.504*G)+(0.098*B)+16;

Cr=(0.439*R)−(0.368*G)−(0.071*B)+128; and

Cb=−(0.148*R)−(0.291*G)+(0.439*B)+128,

where R, G, and B are the components for the respective colors red, green and blue, and Y corresponds to luminance, Cr corresponds to the R-Y signal, and Cb corresponds to the B-Y signal. In accordance with the present invention, color space conversion and scaling engine may be used to change the subsampling from YCbCr 4:4:4 to YCbCr 4:2:2, 4:2:0, or 4:1:1 in response to an indicator (as explained later and provided from power mode 110, ambient light sensor 120 or resource usage monitor 130, FIG. 2), and thereby, the bus BW and memory usage would decrease.

Note that there are many possible selections for an image file format, with some choices providing speed increases and better compression than other choices. Some choices of image file formats may reduce banding or signal loss. In addition to the image file format, some embodiments of microprocessor core 20 may also include a color lookup table (not shown) to optimize mixtures of red, green and blue pixels for displaying images on output device 40. It should be noted that the choice of an image file format and the method of optimizing mixtures of colors for use in system 10 is not intended to limit the scope of the claimed subject mater.

Microprocessor core 20 may receive digital image data and perform any of a variety of operations, such as gamma correction, image noise filtering, pixel cluster averaging, color deepening and contrast enhancement, data compression and output data formatting. Thus, in some applications, system 10 may be dominated by the data traffic from system resources block 90 to memory blocks 30 and 70, combined with the data traffic from the memories to output device 40 to satisfy the monitor refresh rate. In addition to the refresh rate, the bandwidth of the signal provided by microprocessor core 20 to output device 40 generally depends on the horizontal and vertical resolution of the monitor's image plane and the number of bits-per-pixel displayed.

In general, output device 40 is described throughout as a monitor such as, for example, a Liquid Crystal Display panel for displaying video or image data, but in some applications may also be a storage device such as a disk drive or a wireless communications device. When the embodiment is a wireless device, output device 40 may include a radio frequency oscillator to generate a carrier signal and a modulator to modulate the carrier signal with the output image data for broadcasting the image to another communications device.

FIG. 2 is a block diagram that further illustrates the controls within display control block 80 to manage system bandwidth. Display control block 80 includes a power mode block 110, an ambient light sensor 120 and a resource usage monitor 130 that may provide inputs to an adaptive color depth control block 140. Color depth control block 140 provides a signal to output controller block 150, which in turn supplies digital data in a format suitable for display by output device 40.

Power mode block 110 may provide an input to adaptive color depth control block 140 that indicates the power consumption of microprocessor core 20 or system 10. The power consumption for battery-powered portable devices may be based on a current loading profile or the state of the battery, or both.

Ambient light sensor 120 provides an input to adaptive color depth control block 140 that indicates the ambient lighting conditions that may affect a users viewing of the LCD panel in output device 40. A sensing device such as, for example, a photodiode or an opto-transistor may be appropriately placed to sense the ambient lighting conditions. Alternatively, a portion or all of arrayed pixel sensors or a photoactive semiconductor device in a matrix of charge-coupled devices may be sampled to sense ambient lighting conditions. Thus, the input provided by ambient light sensor 120 to adaptive color depth control block 140 may monitor ambient lighting that may affect the viewing conditions of the LCD panel. The ambient environment may also be detected through a periodic exposure-metering algorithm, which generates statistics on the response of the array of photoactive elements.

Resource usage monitor 130 provides an input to adaptive color depth control block 140 that indicates the activity of use within microprocessor core 20. One use indicator may be communication bandwidth, monitored by internal activity on bus 100 and/or activity on bus 60. Bus activity may be based in part on the panel size of output device 40, the number of image planes available for display on the LCD and the number of bits-per-pixel supplied to the display for each of the three primary colors. A high communication bandwidth may limit data traffic on these buses. This communication bandwidth may be indicated by various components associated with the bus such as, for example, the time to get the bus or how long it takes for arbitration. Another use indicator may be based on the operation of system 10 in various applications, with some applications reaching high processing bandwidth conditions as indicated by memory usage and microprocessor usage. A high processing bandwidth may prevent some applications from running or other applications from running concurrently within system 10. Thus, resource usage monitor 130 may provide an input to adaptive color depth control block 140 that monitors communication bandwidth, processing bandwidth, or both, and indicates the activity of use within microprocessor core 20.

Adaptive color depth control block 140 may receive input signals from power mode block 110, ambient light sensor 120 and/or resource usage monitor 130. Any of these three input signals may allow adaptive color depth control block 140 to adjust the performance of system 10 through adaptation of the number of bits-per-pixel for each of the three primary colors, e.g., the color depth of the image file, supplied to the display.

Without adjusting the color depth based on an input from power mode block 110, the battery power may undesirably drop below a threshold voltage value or the microprocessor may be limited from running some applications. Without adjusting the color depth based on an input from ambient light sensor 120, the bandwidth of system 10 would be unchanged for a brightly lit environment and a poorly lit environment, and thus, unaffected by a users ability to perceive a displayed image and the capability of the display panel to provide an accurate color representation. Without adjusting the color depth based on an input from resource usage monitor 130, applications may stall while waiting for data and this may potentially cause user observable degradation in performance or applications to drop frames of data, which potentially may cause observable degradation in the quality of the image.

Upon receiving one or more of the input signals, adaptive color depth control block 140 may either reduce or increase the number of bits-per-pixel supplied to the display. By way of example, the input from power mode block 110 may indicate a high power consumption of microprocessor core 20 or system 10. To extend the battery life before a recharge, adaptive color depth control block 140 may reduce the color depth of the signals presented to output device 40. The input signal received from ambient light sensor 120 may show that the environment is brightly lit, and in this case adaptive color depth control block 140 may act to reduce the color depth without noticeably affecting the image viewed on the LCD. On the other hand, when the environment is poorly lit, adaptive color depth control block 140 may increase the color depth to improve the image viewed on the LCD. The input signal received from resource usage monitor 130 provides an indication of bandwidth that may be used by adaptive color depth control block 140 to decrease the color depth, and thereby, improve the available bandwidth.

By way of example, when the LCD monitor in output device 40 has an image plane resolution of 320 by 240, a 32 bpp format may provide for a bus bandwidth of about 2.4 megabits per second. Adaptive color depth control block 140 may act in response to one of the input signals to reduce the color depth to a 24 bpp format, and thereby, reduce the bus bandwidth to about 1.8 megabits per second. Adaptive color depth control block 140 may again act in response to one of the input signals to further reduce the color depth to an 8 bpp format, and thereby, reduce the bus bandwidth to about 0.6 megabits per second. Again, it should be noted that the image data may be changed from RGB 5:6:5 format to RGB 5:5:5 format, for example, to provide smaller reductions in bus bandwidth.

Further, the power consumption of system 10 may be reduced when microprocessor core 20 operates in the standby mode. In the standby mode, the LCD panel may be refreshed about 70 times per second, although this refresh rate is an example and not limiting to the subject matter of the claimed invention. Referring to FIG. 1, display control block 80 may receive a power mode status signal that places microprocessor core 20 in the standby mode, causing the resolution of the image data being supplied via a bus to output device 40 to be reduced, and thereby, conserving the power consumption of system 10.

By way of example, output device 40 may be an LCD panel with an image plane resolution of about 640 by 480. The image resolution may be reduced by about 25 percent and still provide an acceptable image quality in the standby mode. Typically, the backlight for the LCD panel is turned off in the standby mode, further reducing the chances of the user noticing too much image degradation when the image resolution is reduced. When system 10 is no longer in the standby mode, the backlight is turned on and display control block 80 operates to restore the image resolution to the original.

By way of example, when the LCD monitor in output device 40 has an image plane resolution of 1280 by 1024, a 16 bpp format may provide for a bus bandwidth of about 183 megabits per second. Display control block 80 may act in response to the standby mode to reduce the resolution to 1024 by 768, and thereby, reduce the bus bandwidth to about 110 megabits per second.

Alternatively, display control block 80 may reduce the resolution to about 800 by 600, and thereby, reduce the bus bandwidth to about 67 megabits per second.

The reduction in resolution lowers the power consumption of system 10 by reducing the bus bandwidth and reducing the toggling activity of the LCD drivers. Note that the extent of image resolution reduction may be programmable and linked to a user selectable lowest power battery saving policy or highest system performance. The resolution may be reduced through either hardware or software by block filtering, sub-sampling of the image or interpolation, among others. A lower spatial resolution along with a reduced color depth may further reduce the system power consumption.

In addition to the inputs received from power mode 110, ambient light sensor 120 or resource usage monitor 130, adaptive color depth control block 140 may alter the color depth in response to the Operating System (OS), a position of output device 40, or an indicator that responds to whether the user is actually viewing the display. Changing the color depth may reduce bandwidth and power. Note that the phrase “image file” may refer to information that is stored, but the claimed subject matter may also apply to information in a data stream that is not stored by system 10.

By now it should be clear that embodiments have been presented for mobile multimedia devices that provide a user with a low power solution and at the same time, an enjoyable viewing experience. In addition, bandwidth adjustments have been presented without sacrificing the color in the display panel.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A circuit comprising:
an adaptive color depth control block to adjust bandwidth of a bus coupled to an output of the circuit by changing a color depth for image data in response to a sensed input signal.

2. The circuit of claim 1, wherein the sensed input signal indicates a power consumption of the circuit.

3. The circuit of claim 2, wherein the power consumption of the circuit is based on a current loading profile for the circuit.

4. The circuit of claim 2, wherein the power consumption of the circuit is based on a state of a battery coupled to the circuit.

5. The circuit of claim 1, wherein the sensed input signal indicates an ambient lighting condition for an environment that affects a user operating the circuit.

6. The circuit of claim 5, wherein the sensed input signal adjusts the bandwidth of the bus to increase the bandwidth when the ambient lighting condition is for a poorly lit environment and decreases the bandwidth when the ambient lighting condition is for a brightly lit environment.

7. The circuit of claim 5, wherein the sensed input signal adjusts the bandwidth of the bus to increase the bandwidth when the ambient lighting condition is for a brightly lit environment and decreases the bandwidth when the ambient lighting condition is for a poorly lit environment.

8. The circuit of claim 1, wherein the sensed input signal indicates an activity of use within the circuit.

9. The circuit of claim 8, wherein the activity of use is in accordance with a communication bandwidth of the bus.

10. The circuit of claim 8, wherein the activity of use is in accordance with memory usage and microprocessor usage.

11. A circuit comprising:
a power mode block to sense power consumption of the circuit;
an ambient sensor to sense ambient lighting conditions for a user of the circuit;
a resource usage monitor to sense activity of the circuit; and
an adaptive color depth control block to change a color depth for an image data in response to at least one sensed signal from the power mode block, the ambient sensor and the resource usage monitor.

12. The circuit of claim 11, wherein the adaptive color depth control block adjusts bandwidth of a bus coupled to an output of the circuit in accordance with the change to the color depth for the image data.

13. The circuit of claim 11, further including a memory coupled to the circuit wherein the resource usage monitor senses activity of the circuit in accordance with memory usage.

14. The circuit of claim 11, wherein the power consumption of the circuit is based on a current loading profile for the circuit.

15. The circuit of claim 11, wherein the power consumption of the circuit is based on a state of a battery coupled to the circuit.

16. A method, comprising:
reducing current in a microprocessor in a standby mode by reducing the resolution provided via a bus to a display; and
adjusting bandwidth of data on the bus by changing a color depth for image data in response to a sensed signal.

17. The method of claim 16, wherein changing the color depth for the image data further includes storing the image data as a data file in a memory controlled by the microprocessor.

18. The method of claim 16, wherein changing the color depth for the image data further includes changing image data in a data stream that is not stored in a memory controlled by the microprocessor.

19. The method of claim 16, wherein changing the color depth for an image data further includes generating the sensed signal in accordance with a power consumption of the microprocessor.

20. The method of claim 16, wherein changing the color depth for an image data further includes generating the sensed signal in accordance with an ambient lighting condition for an environment that affects a user operating the microprocessor.

21. The method of claim 16, wherein changing the color depth for an image data further includes monitoring an activity of use within the microprocessor to generate the sensed signal.

22. A method, comprising:
providing data to a display for displaying an image having a first resolution;
placing a microprocessor in a standby mode; and
reducing bandwidth of the data provided by the microprocessor to the display by providing data having a second resolution that is lower than the first resolution.

23. The method of claim 22, further comprising:
restoring the bandwidth of the data provided by the microprocessor to the display by providing data having the first resolution when the microprocessor is not in the standby mode.
